(19) United States
(12) Patent Application Publication
(10) Pub. No.: US 2013/0198945 A1
(43) Pub. Date: Aug. 8, 2013

(54) FLUID DISPLACEMENT DEVICE

(71) Applicant: Nigel McGowan, Douglas (GB)

(72) Inventor: Nigel McGowan, Douglas (GB)

(73) Assignee: DRY PLANET LIMITED, Douglas (GB)

(21) Appl. No.: 13/699,432

(22) PCT Filed: May 23, 2011
(86) PCT No.: PCT/GB2011/050961

§ 371 Date: Jan. 29, 2013

(30) Foreign Application Priority Data
May 21, 2010 (GB) 1008482.0

(51) Int. Cl. E03D 1/14; F16M 13/02

(52) U.S. Cl. CPC E03D 1/14; F16M 13/02
USPC 4/415; 29/428; 248/213.2

(57) ABSTRACT

A fluid displacement device (2) comprises a flexible plastics container (4). The container (4) is formed from a single sheet of PET/PE which is folded over to create a pocket, and heat sealed along the seams 8a,b,c formed by the edge of the sheet. The container (4) is substantially rectangular in shape, and measures approximately 130 mm by 200 mm. The container is placed in a toilet cistern and suspended above a bottom part thereof. Water flows into the flexible container (4) from the cistern (20) through the holes (6) and comes into contact with the water-swellable polymer. The water-swellable polymer absorbs the water and swells to approximately (400) times its original weight to displace approximately 500 ml water from the cistern (20).

The present invention relates to a device for the displacement of fluid in a fluid containing receptacle.

In particular, the present invention relates to a device for displacing a predetermined volume of water in a water tank, for example a toilet cistern.

Water tanks, for example toilet cisterns, often hold more water than is necessary. In the toilet cistern example, a cistern is often able to hold between 8 and 13 litres of water. However, an effective flush of the toilet only requires around 6 or 7 litres of water. Therefore, in a normal toilet, between approximately 1 and 6 litres of water can be wasted in each flush.

Devices for the displacement of water in a toilet cistern have previously been developed. These devices comprise weights, such as bricks, which sit at the bottom of the toilet cistern and displace a volume of water.

Other devices comprise sachets or pouches filled with water-swellable polymers which increase in volume upon entry in the water. These devices too sit on the bottom of the toilet cistern.

The devices described above are all adapted to sit on the bottom of a toilet cistern. However, some toilet cisterns, instead of using a siphon valve, comprise a flapper valve. The flapper valve is located in the bottom of the cistern to allow water in the cistern to empty through the bottom of the cistern when the valve is opened.

In view of the location of the flapper valve, it is not possible to use the above described water displacement devices with these types of cisterns. The displacement device can interfere with the movement of the valve meaning that either no water can be emptied from the cistern, or the valve is kept open leading to leakage and wasting of water.

Furthermore, in cisterns fitted with a dual flush system, not all of the water is emptied from the cistern with each flush. There is always a volume of water left in the bottom of the cistern. Therefore, because the devices sit on the bottom of the cistern, below the level of water left in the cistern in each flush, the water displacement devices described above would not result in any water being saved in a dual flush system.

It is an object of the present invention to address these and other problems associated with the prior art.

According to a first aspect of the present invention, there is provided a fluid displacement device to displace a volume of fluid within a fluid tank, the device comprising retaining means to retain the device within the tank.

Preferably, the retaining means is operable to retain the fluid displacement device within an upper portion of the fluid tank.

Preferably, the fluid displacement device is adapted to displace a certain volume of fluid from the fluid tank. The fluid displacement device may be operable to displace between 0.1 and 3 litres, preferably between 0.3 and 1.5 litres, most preferably 0.5 litre of fluid from a tank.

Preferably, the fluid displacement device comprises a flexible container.

Preferably, the fluid displacement device comprises a fluid-swellable material. Preferably, the flexible container comprises a fluid-swellable material. Preferably, the fluid-swellable material is a super-absorbing polymer. The super-absorbing polymer is preferably operable to swell to a certain volume upon exposure to fluid. The super absorbent polymer may be operable to swell upon exposure to fluid to occupy up to 400 times its weight in the unexposed state.

Preferably, the polymer is a potassium cross-linked polyacrylamide, more preferably of the type available as Hydropol.

Preferably, the fluid-swellable material is provided in the flexible container in granular form.

Preferably, the fluid displacement device comprises an attachment means to allow attachment to the retaining means. Preferably, the attachment means comprise a cavity within an edge of the fluid displacement device.

Alternatively, the retaining means is integral with the fluid displacement device.

Preferably, the retaining means comprise means for retaining the fluid displacement device relative to the fluid tank. Preferably, the retaining means is adapted to prevent the fluid displacement device from resting on the bottom of the fluid tank. Preferably, the retaining means are operable to retain the fluid displacement device adjacent to a side wall of the fluid tank.

Preferably, the retaining means is operable to engage the attachment means of the fluid displacement device. Preferably, the retaining means comprise a first attachment portion for attaching to the fluid displacement device. Preferably, the retaining means comprise a second attachment portion for attaching to the fluid tank.

Preferably, the first and/or second attachment portions are resiliently biased towards a central stem of the retaining means.

The fluid is preferably water. Preferably, the fluid displacement device is a water displacement device. Preferably, the fluid tank is a water tank. Preferably, the fluid-swellable material is a water-swellable material.

Preferably, the fluid tank is a toilet cistern.

Preferably, the flexible container is perforated to allow a flow of fluid therethrough. The perforations in the flexible container are preferably regularly spaced. For example, the perforations may be spaced at 5 mm, 10 mm, 15 mm or 20 mm intervals. Preferably, the perforations are of a size large enough to allow fluid to flow freely through, but small enough to retain the fluid-swellable material, especially when in granular form. For example, the perforations may be between approximately 0.1 and 1.5 mm in diameter, preferably between approximately 0.5 and 1.0 mm in diameter.

The flexible container is preferably a flexible plastics container, for example a polyester container such as polyethylene (PE) or polyethylene terephthalate (PET). Preferably, the flexible container is biodegradable.

The surfaces of the flexible container may be treated with an antibacterial or antifungal composition to prevent the growth of bacteria or fungi on the container.

Preferably, the fluid displacement device is biodegradable.

Preferably, the fluid displacement device is adapted to abut a side wall of the fluid tank.

Preferably, the fluid displacement device comprises weighting means. Preferably, the weighting means ensure that the device is kept in place in the fluid tank, preferably adjacent a side wall of the tank. Preferably, the weighting means are in a particulate form. This allows weighting means to disperse within the fluid-swellable polymer. Such dispersal leads to an even weighting of the fluid displacement device. Preferably, the weighting means comprise sand.

According to a second aspect of the present invention, there is provided a retaining means for retaining a fluid displacement device within a fluid tank.

Preferably, the retaining means is operable to retain the fluid displacement device within an upper portion of the fluid tank.

Preferably, the retaining means comprise means for retaining the fluid displacement device relative to the fluid tank. Preferably, the retaining means is adapted to prevent the fluid displacement device from resting on the bottom of the fluid tank. Preferably, the retaining means are operable to retain the fluid displacement device adjacent to a side wall of the fluid tank.

Preferably, the retaining means comprise a first attachment portion for attaching to the fluid displacement device. Preferably, the retaining means comprise a second attachment portion for attaching to the fluid tank.

Preferably, the first and/or second attachment portions are resiliently biased towards a central stem of the retaining means.

Alternatively, the second attachment portion may comprise another suitable fixing means, for example a suction cup, an adhesive, or a mechanical fastening such as a nut and bolt.

Preferably, the retaining means is made from a plastics material, for example polypropylene (PP) or polyvinylchloride (PVC). Preferably, the retaining means is biodegradable.

Alternatively, the retaining means may be made from any other suitable material, for example metal or wood.

Preferably, the central stem of the retaining means is between approximately lcm and approximately 20 cm in length, preferably between approximately 5 cm and approximately 17 cm, more preferably approximately 12 cm.

Preferably, the fluid displacement device is the fluid displacement device of the first aspect of the invention. Preferably, the retaining means is operable to engage the attachment means of the fluid displacement device.

Preferably, the retaining means is adapted to be retrofitted to an existing fluid tank.

According to a third aspect of the present invention, there is provided a method of displacing fluid in a fluid tank, the method comprising the steps of retaining a fluid displacement device within the fluid tank using a retaining means.

Preferably, the method comprises the step of retaining the fluid displacement device within an upper portion of the fluid tank using the retaining means

Preferably, the method further comprises the step of engaging an attachment means of the fluid displacement device with the retaining means. Preferably, the method comprises the step of engaging a rim of the fluid tank with the retaining means.

Preferably, the fluid displacement device is the device of the first aspect of the invention.

Preferably, the retaining means is the retaining means of the second aspect of the invention.

According to a further aspect of the present invention, there is provided a kit for displacing fluid in a fluid tank comprising a fluid displacement device and a retaining means for retaining the fluid displacement device within a fluid tank.

Preferably, the retaining means is operable to retain the fluid displacement device within an upper portion of the fluid tank.

Preferably, the kit comprises the fluid displacement device of the first aspect of the invention.

Preferably, the kit comprises the retaining means of the second aspect of the present invention.

Any of the features described herein may be combined with any other described features, and with respect to any aspect of the invention.

The invention will now be illustrated further, by way of example only, with respect to the accompanying drawings, in which:

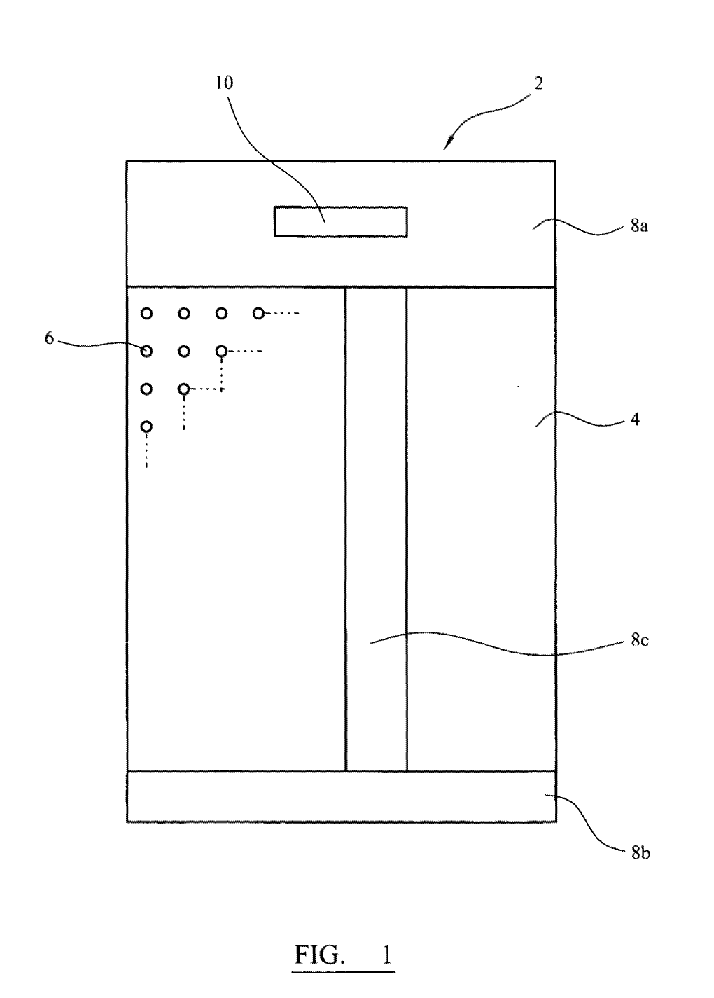

FIG. 1 shows a schematic, perspective view of a water displacement device according to the invention;

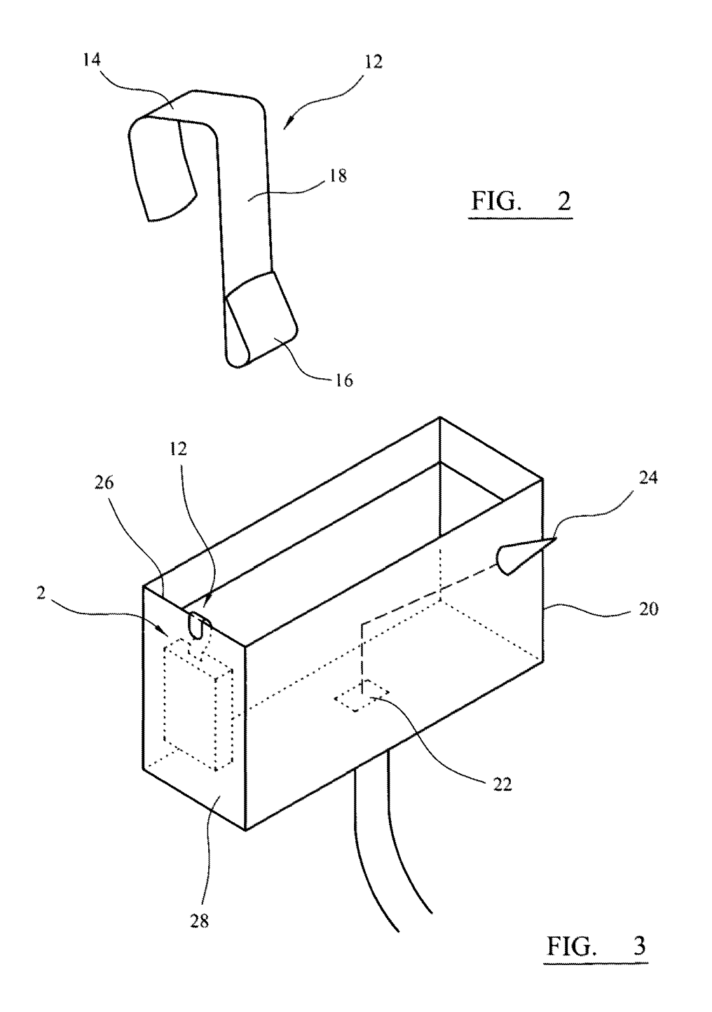

FIG. 2 shows a schematic, perspective view of a retaining means according to the invention;

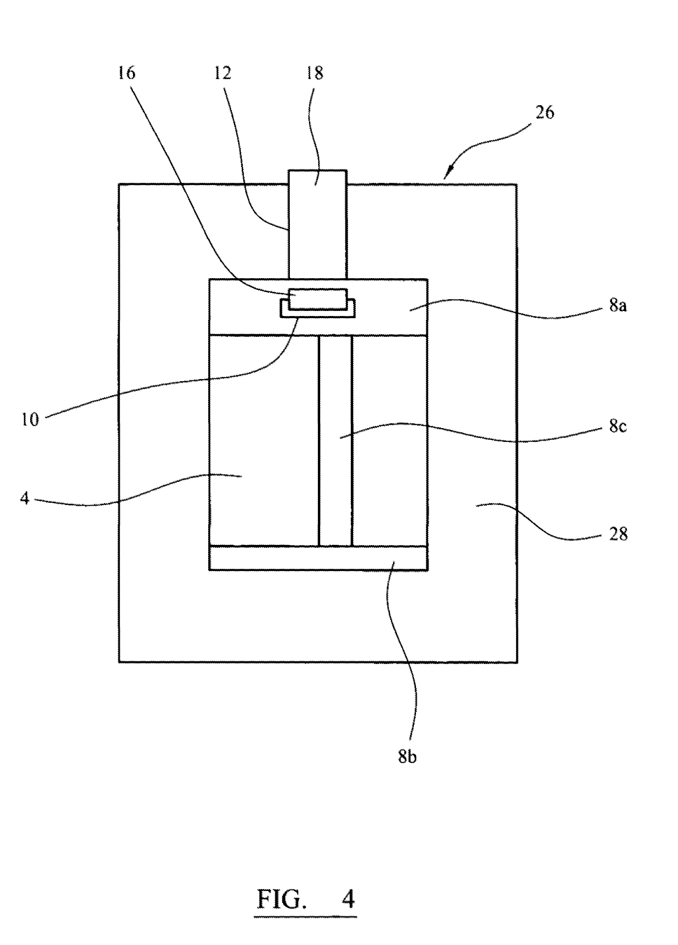

FIG. 3 shows a schematic, perspective view of the water displacement device being retained within a toilet cistern; and

FIG. 4 shows a schematic, plan view of the water displacement device being retained on the side wall of the cistern.

Referring now to FIG. 1, a fluid displacement device 2 comprises a flexible plastics container 4. The container 4 is formed from a single sheet of PET/PE which is folded over to create a pocket, and heat sealed along the seams 8a,b,c formed by the edge of the sheet. The container 4 is substantially rectangular in shape, and measures approximately 130 mm by 200 mm.

The container 4 is perforated by a series of holes 6. The holes 6 are approximately 0.5-0.8 mm in diameter and are regularly spaced at approximately 10 mm intervals.

The container 4 comprises a water-swellable polymer. The water-swellable polymer is a potassium cross-linked polyacrylamide of the type available as Hydropol.

Prior to water exposure, the container 4 comprises approximately 8 g of the water-swellable polymer in granular form.

The container 4 also comprises approximately 75 g of a silica sand.

The container 4 comprises an attachment means 10 to attach the device to a retaining means 12. The attachment means 10 comprise an elongated slot in a heat-sealed edge 8a of the fluid displacement device 2. The edge 8a in which the attachment means 10 is located may comprise a wider heat seal than the other edges 8b,c.

The attachment means 10 may be formed by punching a slot out of the heat-sealed edge 8a of the fluid displacement device 2.

Referring now to FIG. 2, a retaining means 12 comprises a clip. The clip comprises a wide hook portion 14. The wide hook portion 14 is adapted to engage the rim 26 of a toilet cistern, or other fluid tank. The clip further comprises a narrow hook portion 16. The narrow hook portion 16 is adapted to engage the attachment means 10 fluid displacement device 2. The clip may resemble a power wing clip.

The wide hook portion 14 and narrow hook portion 16 are resiliently biased towards a central stem 18 of the retaining means 12 such that the rim of the cistern and the fluid displacement device 2 are held securely by the retaining means 12. Therefore, the retaining means 12 does not easily fall off the rim of the cistern, and the fluid displacement device 2 is not easily dropped from the retaining means 12. This ensures that the retaining means 12 and water displacement device 2 remain in position and can withstand the forces from any movement of fluid in the fluid tank.

Preferably, the retaining means 12 is formed from an extruded plastics material such as polypropylene. The retaining means 12 is preferably approximately 12 cm long along the central stem 18, and approximately 2 cm to 5 cm wide.

Referring to FIGS. 3 and 4, the water displacement device 2 is used to displace water in a toilet cistern 20. The toilet cistern 20 comprises a flapper valve connected to the flush handle 24.

In use, the retaining means 12, as shown in FIG. 2, is set into position with the wide hook portion 14 engaging the rim 26 of the cistern 20. The fluid displacement device 2, as shown in FIG. 1, is then attached to the retaining means 12 by the narrow hook portion 16 and is placed into the toilet cistern 20 such that the device abuts a side wall 28 of the cistern 20. The sand weighs the device 2 down such that it remains in position abutting the side wall 28 of the cistern 20.

Water flows into the flexible container 4 from the cistern through the holes 6 and comes into contact with the water-swellable polymer. The water-swellable polymer absorbs the water and swells to approximately 400 times its original weight to displace approximately 500 ml water from the cistern 20. When the toilet is flushed, less water is used because the water displacement device 2 has displaced approximately 500 ml from the cistern 20.

In an alternative embodiment, the flexible container 4 may be formed from two sheets of polyethylene/polyethylene terephathalate material which are heat sealed around the four edges of the container 4.

In an alternative embodiment, the retaining means 12 may be integrally formed with the fluid displacement device 2. In this case, the attachment means 10 and narrow hook portion 16 would be replaced by an integral attachment means between the fluid displacement device 2 and the retaining means 12.

In a further embodiment of the invention, the retaining means 12 may be integral with the fluid tank, or toilet cistern 20. In this case, the fluid displacement device 2 is attached directly to the fluid tank, or toilet cistern 20, by the attachment means 10.

In yet another embodiment of the invention, the retaining means 12 may comprise an alternative fixing means for fixing to the fluid tank. For example, the retaining means 12 may be fixed to the fluid tank using a suction cup, adhesive, nut and bolt, or any other suitable fixing means. Fixing means that are removable from the fluid tank without causing damage thereto are preferred.

The devices hereinbefore described serve to reduce the volume of fluid stored in fluid reservoirs in systems such as toilet cisterns, washing machines, dishwashers and the like so that only sufficient fluid is stored for the system to perform its job. This allows the systems to perform their jobs properly and efficiently whilst reducing the volume of fluid wasted. This is advantageous both environmentally and in reducing the cost to users, such as people on water meters.

The fluid displacement device of the present invention is adapted to be situated in a position in a fluid tank such that it won't interfere with the workings of any valves located at the bottom of the tank. Therefore, unlike previously known and used displacement devices, the device of the present invention can be used in toilet cisterns having flapper valves.

Furthermore, the fluid displacement device of the present invention is situated in an upper portion of the fluid tank. Therefore, it is effective in displacing, and consequently saving, water in bottom emptying tanks, even when the tank is not fully emptied. Therefore, in dual flush toilet systems, the device of the present invention will result in water being saved even though the cistern is not fully emptied after each flush.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A fluid displacement device to displace a volume of fluid within a fluid tank, the device comprising retaining means to retain the device within the tank.

2. The fluid displacement device as claimed in claim 1, in which the retaining means is operable to retain the fluid displacement device within an upper portion of the fluid tank.

3. The fluid displacement device as claimed in claim 1, which is adapted to displace between 0.1 and 3 litres of fluid from a tank.

4. The fluid displacement device as claimed in claim 1, which comprises a flexible container.

5. The fluid displacement device as claimed in claim 1, in which the fluid displacement device comprises a fluid-swellable material.

6. The fluid displacement device as claimed in claim 5, in which the fluid-swellable material is a super-absorbing polymer.

7. The fluid displacement device as claimed in claim 5, in which the polymer is a potassium cross-linked polyacrylamide.

8. The fluid displacement device as claimed in claim 1, in which the fluid displacement device comprises an attachment means to allow attachment to the retaining means, wherein the attachment means comprise a cavity within an edge of the fluid displacement device.

9. The fluid displacement device as claimed in claim 1, in which the retaining means is adapted to prevent the fluid displacement device from resting on the bottom of the fluid tank.

10. The fluid displacement device as claimed in claim 1, in which the fluid tank is a toilet cistern.

11. The fluid displacement device as claimed in claim 1, in which the flexible container is perforated to allow a flow of fluid therethrough.

12. The fluid displacement device as claimed in claim 1, in which the fluid displacement device comprises weighting means.

13. A retaining means for retaining a fluid displacement device within a fluid tank.

14. A method of displacing fluid in a fluid tank, the method comprising the steps of retaining a fluid displacement device within the fluid tank using a retaining means.

15. The method of displacing fluid in a fluid tank as claimed in claim 14, the method comprising the step of retaining the fluid displacement device within an upper portion of the fluid tank using the retaining means

16. The method of displacing fluid in a fluid tank as claimed in claim 14 or claim 15, wherein the method further comprises the step of engaging an attachment means of the fluid displacement device with the retaining means.

17. A kit for displacing fluid in a fluid tank comprising a fluid displacement device and a retaining means for retaining the fluid displacement device within a fluid tank.

18. The method of displacing fluid in a fluid tank as claimed in claim 14, wherein the method further comprises the step of engaging a rim of the fluid tank with the retaining means.
